(19) United States
(12) Patent Application Publication
(10) Pub. No.: US 2007/0199291 A1
(43) Pub. Date: Aug. 30, 2007

(54) Non chargeable electric lawn mower

(76) Inventor: Roosevelt Tharp, Headland, AL (US)

Correspondence Address: Roosevelt Tharp, 107 A.B. Cotton Dr., Headland, AL, 36345, US

(21) Appl. No.: 11/303,716

(22) Filed: Feb. 27, 2006

(51) Int. Cl. A01D 34/00

(52) U.S. Cl. 56/10.1

(57) ABSTRACT

The non chargeable electric lawn mower is the future. The gas power mower gives us air and noise pollution. The non chargeable electric lawn mower will not pollute the air, less noise, and no gas bill. The non chargeable electric lawn mower is as dependable as the gas power mower and also competitive in cost.

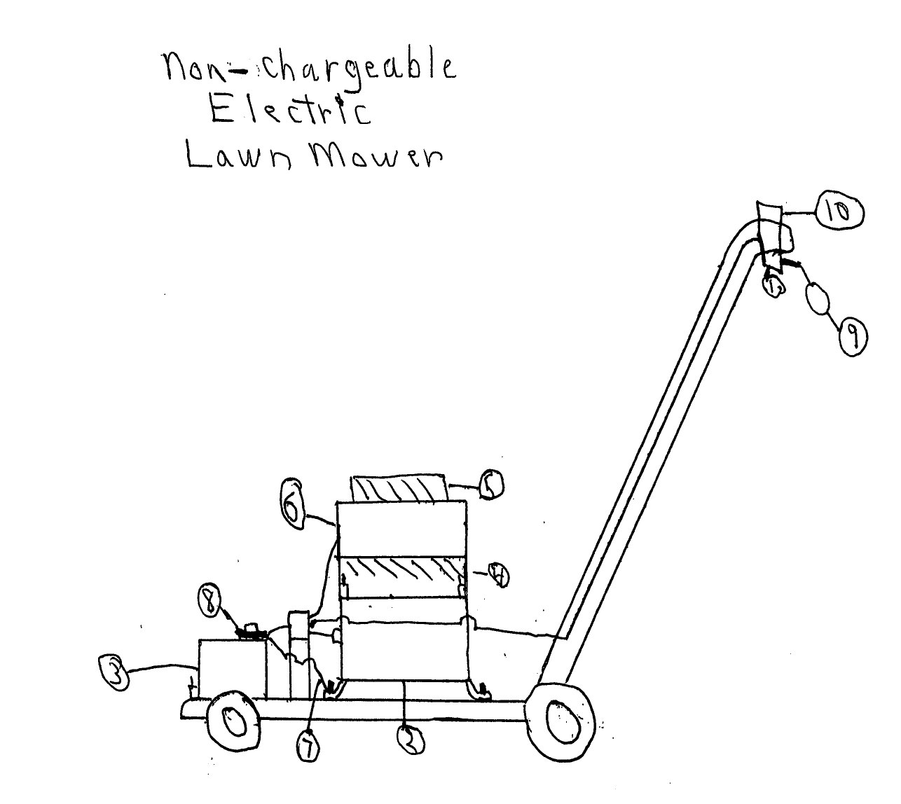

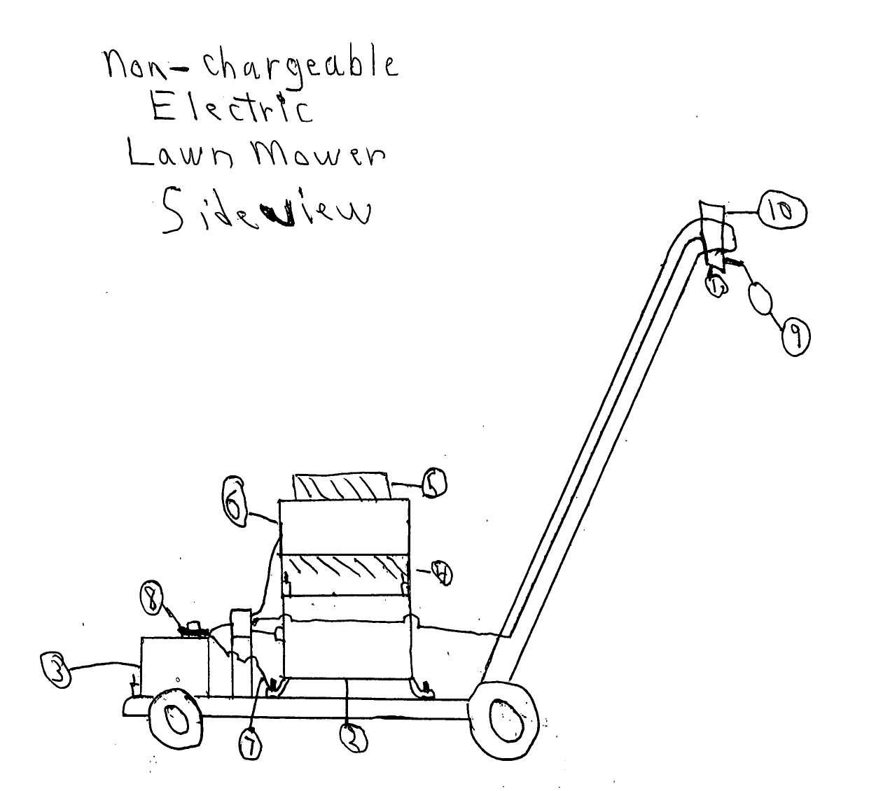

This view of the lawn mower shows all the parts that make up this invention.

The parts has a number attach to them. The next page explain each number.

1. The on and off switch.
2. An electric 4 horse power motor.
3. 12 volt battery.
4. Cooling fan.
5. Cooling fan.
6. Alternator.
7. The negative cable.
8. The positive cable.
9. A safety key.
10. The on and off switch acts as a breaker when the motor is over loader.

1. I claim that my invention is a workable idea. My invention is called non-chargeable electric lawn mower.
How this invention works:
The lawn mower's blade is connected to a shaft that goes into the electric motor and come out on the back side of the motor. The alternator has a shaft that connects to the shaft that comes out on the back side of the motor. The alternator is bolted down to the electric motor. There is fan on the shaft of the alternator. This fan will help kept the electric motor and alternator cool. The alternator will put back power into the battery that starts the electric motor.
The switch that turns the electric motor on act like a breaker when the motor is overloaded.
The switch also has a safety key in it.
This non-chargeable electric lawn mower can play a part in cleaning up our air.
